(19) United States
(12) Patent Application Publication
(10) Pub. No.: US 2004/0044768 A1
(43) Pub. Date: Mar. 4, 2004

(54) Reverse proxy mediator for servers

(75) Inventor: Koichi Takahashi, Sagamihara-shi (JP)

Correspondence Address: A. Bruce Clay, IBM Corporation, T81/503, PO BOX 12195, Research Triangle Park, NC, 27709, US

(73) Assignee: International Business Machines Corporation, Armonk, NY (US)

(21) Appl. No.: 10/653,666

(22) Filed: Sep. 2, 2003

(30) Foreign Application Priority Data
Mar. 9, 2002 (JP) 2002-257969

(51) Int. Cl. G06F 15/173

(52) U.S. Cl. 709/225

(57) ABSTRACT

A Set-Cookie header rewriting part of a reverse proxy receives an HTTP response from a web server, and deletes the domain parameter included in the header. The components of the domain parameter are rearranged into inverse order, and the rearranged components are embedded in the HTTP response. This puts the HTTP response in a format recognizable by the user terminal. A link/location header rewriting part rewrites the domain and path of a link and location into a format conforming to the HTTP response that was rewritten by the Set-Cookie header rewriting part. An HTTP response sending part sends the rewritten HTTP response to the user terminal.

### TECHNICAL FIELD OF THE INVENTION

This invention relates to a reverse proxy that mediates between servers on a network and external networks, and particularly to processing on the reverse proxy when the servers set cookies.

### BACKGROUND OF THE INVENTION

A reverse proxy is placed on a network to enhance security for servers that provide various kinds of services through the network. The reverse proxy is a proxy server receiving and relaying requests on behalf of the servers. Since all users can access the servers only via the reverse proxy, the servers are never directly accessed from the outside.

When accessing the servers via the reverse proxy, the following formats are typically used to send the access requests:

(1) http://<reverse proxy>/<prefix>/<path name of web server>, and

(2) http://<web server>/<path name of web server>,

where HTTP (Hypertext Transfer Protocol) is used as the communication protocol. The following describes a case of accessing a web server using HTTP.

The reverse proxy manages a table defining correspondence between <prefix> and each server name as shown in FIG. 12. When receiving a request in format (1), the reverse proxy references the table of FIG. 12 and sends a request in format (2) to a web server corresponding to <prefix> in the request.

Since HTTP requests are stateless, that is, independent of each other, even when receiving consecutive requests from one user, the web server recognizes them as individual requests. Therefore, a cookie is introduced to maintain user state between the requests.

The web server sets a cookie in the user's browser so that it can track the user behavior, for example, in the following manner:

When returning a response to a request from the user, the web server first embeds a Set-Cookie in the header of the response such as the following:

Set-Cookie: id=001

From then on, a cookie like the following is embedded in all request headers from the user:

Cookie: id=001

Based on this information, the web server can track what pages the user has accessed.

The header with the embedded Set-Cookie (hereinbelow called the Set-Cookie header) has the following syntax:

Set-Cookie: <name>=<value>; domain=<domain>; path=<path>; etc.

From the specification of the domain and path, the browser receiving the Set-Cookie header limits the scope of the cookie to be returned. In other words, the cookie is returned only in the case of accessing a directory and subdirectories specified by the path parameter in a web server within the scope specified by the domain parameter.

However, in a network system having such a reverse proxy in place, the following problem arises. When a response to a request sent from the reverse proxy to a server (for example, a response to a request in format (2)) includes a Set-Cookie header, if the reverse proxy returns the response as it is to a browser (user terminal) originating the request, the browser cannot accept the Set-Cookie properly by definition.

The reason for this is that although the scope of the Set-Cookie is determined by the parameter specifying the path, the original domain and path of the server are different from those through the reverse proxy. For example, when the web server has set a Set-Cookie by setting for the domain parameter the value of the domain to which the web server itself belongs, if the reverse proxy recognizable by the browser does not exist in the domain specified in the Set-Cookie, the browser will ignore the Set-Cookie.

### SUMMARY OF THE INVENTION

It is therefore an object of the invention to transparently handle a cookie set by a server in a network system in which a client accesses the server via a reverse proxy.

It is another object of the invention to provide a reverse proxy with set-Cookie rewriting capability for effective use of the cookie set by the server.

In attaining the above objects, the invention is realized by the following network system, namely, a network system including multiple web servers provided on a network and a reverse proxy relaying external access to the multiple web servers. In the network system, each of the web servers responds to a request from a certain terminal connected to the network to return to the terminal a response including information for maintaining the state of the terminal. The reverse proxy converts the information, included in the response for maintaining the state of the terminal, into a format recognizable by the terminal as the configuration of the network, and returns the response with the converted information. In other words, the reverse proxy deletes the domain parameter specifying the domain of the web server included in the information for maintaining the state of the terminal, rearranges the components of the domain parameter in inverse order, and embeds the rearranged domain parameter into the path parameter of the web server included in the information.

The invention is also realized by a reverse proxy having the following functional configuration. Namely, a reverse proxy relaying data from a web server to a user terminal includes: a header rewriting part for receiving the data returned from the web server to the user terminal, and rewriting the description of the domain and path of a Set-Cookie header included in the data into a format recognizable by the user terminal; and a data sending part for sending the user terminal the data rewritten by the header rewriting part. The reverse proxy may further include a link/location rewriting part for rewriting the domain and path of a link and location included in the data in conformity to the path including the description of the domain rewritten by the header rewriting part.

Further, the invention is realized by a reverse proxy having the following functional configuration. Namely, a reverse proxy relaying a request from a user terminal to a web server includes: a web server name acquiring part for identifying the web server, to which the request is to be sent, from among multiple servers on the network based on information (domain related information) obtained by converting the description of the received request; a URL rewriting part for rewriting the access destination of the request to the URL of the web server based on the web server identified by the web server name acquiring part; and a request transfer part for transferring the request to the URL of the web server.

Furthermore, the invention can provide the following computer equipment, namely, computer equipment relaying the transmission of an HTTP request and the return of an HTTP response between a terminal and a server. The computer equipment includes HTTP request transfer means for relaying the HTTP request with a cookie sent from a browser of the terminal to transfer it to the server as the destination of the HTTP request; and HTTP response transfer means for receiving the HTTP response returned from the server in response to the HTTP request, deleting the domain described in a Set-Cookie header, rearranging the components of the domain in inverse order, embedding the rearranged components into the path described in the Set-Cookie header, and transferring the HTTP response with the Set-Cookie header to the terminal. In this configuration, when a port other than the default port is in use on the web server, the HTTP request transfer means specifies the port number of the web server in the access path of the browser to the reverse proxy to access the web server. The HTTP response transfer means may add a predetermined fixed-character string to the Set-Cookie header according to the HTTP response to transfer the HTTP response with the Set-Cookie header to the terminal. Further, the HTTP response transfer means may replace the domain parameter of the server in the Set-Cookie header by its own server name to transfer the HTTP response to the terminal.

Furthermore, the invention can provide the following data processing method. Namely, a data processing method for computer equipment relaying data exchanged between first computer equipment and second computer equipment includes the steps of: receiving a response sent from the first computer equipment to the second computer equipment; determining whether the response includes a Set-Cookie header; rewriting the Set-Cookie header when the response includes the Set-Cookie header so that a cookie set on the second computer equipment based on the Set-Cookie header will have a format recognizable by the second computer equipment, and sending the second computer equipment the response with the rewritten Set-Cookie header.

The data processing method for computer equipment relaying data exchanged between first computer equipment and second computer equipment may also include the steps of: receiving a request sent from the second computer equipment; identifying the first computer equipment sending the request based on information obtained by converting the request information; rewriting the access destination of the request to the URL of the first computer equipment; and sending the request to the URL of the first computer equipment identified.

In addition, the invention can be realized by a program controlling a computer to perform each step of the above-mentioned method for performing data processing or processing performed by each of the functional parts. The program may be distributed in the form of a storage medium such as a magnetic disk, optical disk, semiconductor memory, or any other recording medium, or delivered through a network.

### BRIEF DESCRIPTION OF THE DRAWINGS

A preferred embodiment of the invention will now be described in more detail, by way of example only, with reference to the accompanying drawings, in which:

FIG. 1 is a schematic diagram showing the configuration of a network system in accordance with an embodiment of the present invention;

FIG. 2 is a block diagram showing functional blocks of a reverse proxy in accordance with an embodiment of the present invention;

FIG. 3 shows conversion rules in a Set-Cookie header rewriting part;

FIG. 4 is a diagram showing a flow of data in the network system in accordance with an embodiment of the present invention;

FIG. 5 shows web servers as the scope of cookies converted according to the conversion rules in accordance with an embodiment of the present invention;

FIG. 6 shows examples of Set-Cookie headers with reversed FQDNs corresponding to respective cases;

FIG. 7 is a flowchart showing processing in the reverse proxy in accordance with an embodiment of the present invention;

FIG. 8 shows an example of response data received at the reverse proxy;

FIG. 9 shows an example of response data with a Set-Cookie header rewritten by the reverse proxy in accordance with an embodiment of the present invention;

FIG. 10 shows an example of response data to be sent from the reverse proxy;

FIG. 11 is a schematic diagram showing the scope of cookies decided by Set-Cookie headers sent from web servers, and examples of HTTP requests and cookies to be sent to corresponding web servers as the scope of the cookies; and

FIG. 12 shows a table managed in the reverse proxy.

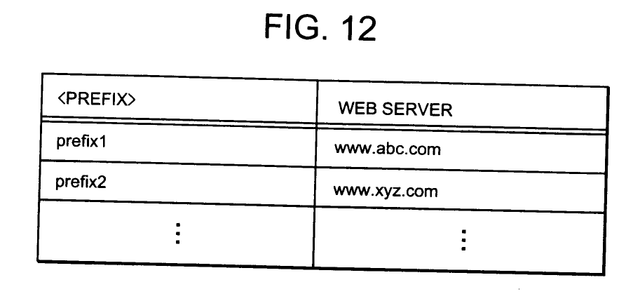

### DETAILED DESCRIPTION OF THE INVENTION

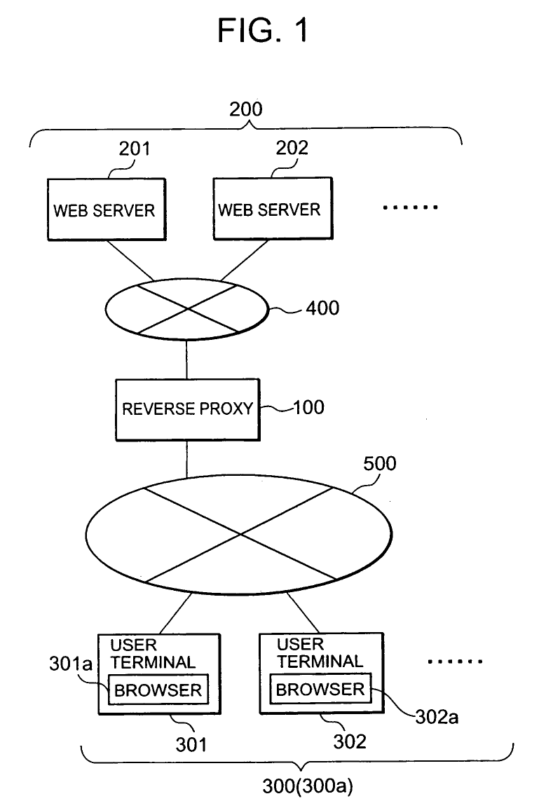

As shown in FIG. 1, the network system includes web servers 200, a reverse proxy 100, and user terminals 300. The web servers 200 provide content in response to requests and return cookies. The reverse proxy 100 relays the requests to the web servers 200 and responses from the web servers 200 to the requests through a network 400 such as a LAN network. The user terminals 300 are connected to the reverse proxy 100 through a network 500 such as the Internet to send the requests to the web servers 200 and receive the responses from the web servers 200.

As shown, in the network system of FIG. 1, the web servers 200 are multiple web servers 201, 202, etc. having different domains from each other. The web servers 200 are accessible by any of multiple terminals 301, 302, etc. with respective browsers 301a, 302a, etc. The following assumes that even when the terminals accessing any web server 200 are physically one terminal, they are deemed different according to the user log-in names.

The embodiment will be described by taking a case where HTTP is used as the communication protocol to send and receive HTTP requests and HTTP responses between the web servers 200 and the user terminals 300.

Each of the web servers 200 shown in FIG. 1 may be a computer with sufficient capabilities to withstand an access load from the outside. The web server 200 returns data or a file (an HTTP response) to provide content in response to an HTTP request from each of the user terminals 300. The web server 200 adds a Set-Cookie header in the HTTP response prior to returning the HTTP response to the user terminal 300. The HTTP response returned from the web server 200 is first received by the reverse proxy 100 positioned between the web server 200 and the user terminal 300. In the present embodiment, the HTTP response with the Set-Cookie header embedded by the web server 200 is converted by the reverse proxy 100 into a predetermined format.

The reverse proxy 100 may be a computer with network capability to relay the HTTP request and HTTP response between the web server 200 and the user terminal 300. The reverse proxy 100 relays the HTTP request from the user terminal 300 to the web server 200 specified by the HTTP request. Further, the reverse proxy 100 relays the HTTP response from the web server 200 in response to the transferred HTTP request.

In this embodiment, the reverse proxy 100 receives the HTTP response including the Set-Cookie header from the web server 200, and converts the Set-Cookie header in the HTTP response into a predetermined format. Further, the reverse proxy 100 rewrites a link and location header included in the HTTP response, and sends to the user terminal 300 the HTTP response with the Set-Cookie header and the link location header rewritten. These capabilities realized by the reverse proxy 100 will be subsequently described in greater detail.

Each of the user terminals 300 may be a personal computer or workstation. The user terminal 300 has operating devices such as a keyboard, a mouse, and a display device such as a monitor. The user terminal 300 is also equipped with a browser 300a operating under program control. The browser 300a not only displays a browser window (screen) on the display device according to the operations of the operating devices, but also manages cookies set by different web servers 200. When a user operating the user terminal 300 performs predetermined operations on the browser window, the browser 300a sends, for example, an HTTP request to one of the networked web servers 200. The web server 200 returns an HTTP response in response to the HTTP request, and the user terminal 300 allows the browser 300a to display contents on its browser window based on the HTTP response returned from the web server 200.

Further, a cookie is set in the browser 300a based on the Set-Cookie header embedded in the HTTP response returned from the web server 200. The browser 300a keeps or stores the cookie on the user terminal 300 so that the cookie will be embedded in the next or later HTTP request to the web server 200 within the scope of the cookie prior to sending the HTTP request. The web server 200 receiving the HTTP request including the cookie preserves a correlation between the HTTP request and later HTTP requests sent from the same user terminal 300 to maintain the state of the user terminal 300.

The following will describe how the reverse proxy 100 functions, focusing on Set-Cookie headers included in HTTP responses returned from the web servers 200 based on HTTP requests sent from the user terminals 300.

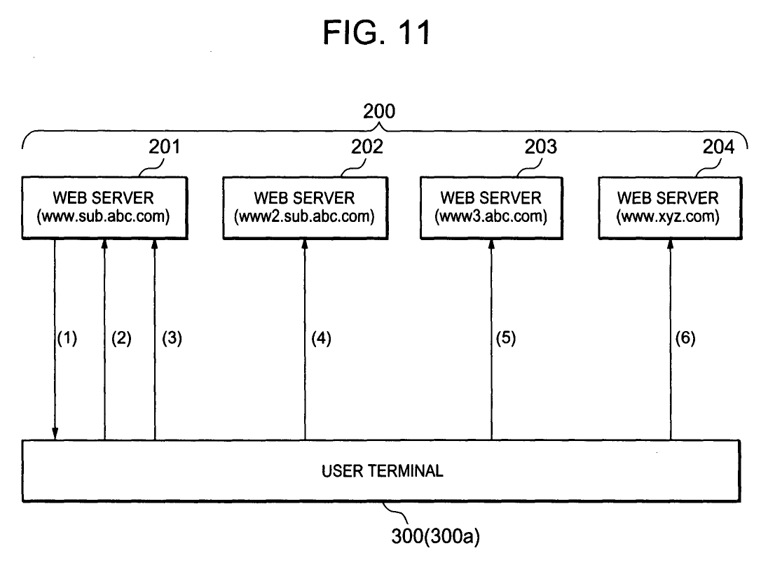

Domain and path parameters are described in each of the Set-Cookie headers included in the HTTP responses. Based on the information on the domain and path parameters, the scope of a cookie is set in the browser 300a of the user terminal 300. FIG. 11 describes the Set-Cookie headers included in HTTP responses returned from the web servers 200 to the user terminals 300, and cookies embedded in request headers of HTTP requests sent from the user terminals 300 to the web servers 200.

FIG. 11 schematically shows the scope of cookies decided by Set-Cookie headers sent from the web servers 200, and examples of HTTP requests with cookies sent to corresponding web servers 200 within the scope of the cookies. In the illustrated example, multiple web servers 200, namely a web server 201 (domain: “www.sub.abc.com”), a web server 202 (domain: “www2.sub.abc.com”), a web server 203 (domain: “www3.abc.com”), and a web server 204 (domain: “www.xyz.com”), are placed on the network. The user terminal 300 exchanging HTTP requests and HTTP responses with the web servers 200 is connected through the network.

The web server 201 returns HTTP responses including the following Set-Cookie headers (1) according to the HTTP requests from the user terminal 300:

(1) Set-Cookie: name1=value1; domain=www.sub.abc.com; path=/

Set-Cookie: name2=value2; domain=www.sub.abc.com; path=/path1/

Set-Cookie: name3=value3; domain=sub.abc.com; path=/

Set-Cookie: name4=value4; domain=abc.com; path=/

Based on the Set-Cookie headers (1), cookies are set and kept in the browser 300a of the user terminal 300. The scope of the cookies set based on the Set-Cookie headers (1) are as follows:

name1: www.sub.abc.com

name2: www.sub.abc.com/pathl

name3: www.sub.abc.com; www2.sub.abc.com

name4: www.sub.abc.com; www2.sub.abc.com; www3.abc.com

In the example shown in FIG. 11, when an HTTP request should be sent from the user terminal 300 to the web server 201, the following cookie is embedded in the request header of the HTTP request based on the scope of the cookie kept in the browser 300a:

(2) GET /index.html

Cookie: name1=value1; name3=value3; name4=value4

When an HTTP request should be sent from the user terminal 300 to a directory (“/path1/”) of the web server 201, the following cookie is embedded in the request header of the HTTP request based on the scope of the cookie kept in the browser 300a:

(3) GET /path1/index.html

Cookie: name1=value1; name2=value2; name3=value3; name4=value4

When an HTTP request should be sent from the user terminal 300 to the web server 202, the following cookie is embedded in the request header of the HTTP request based on the scope of the cookie kept in the browser 300a:

(4) GET /index.html

Cookie: name3=value3; name4=value4

When an HTTP request should be sent from the user terminal 300 to the web server 203, the following cookie is embedded in the request header of the HTTP request based on the scope of the cookie kept in the browser 300a:

(5) GET /index.html

Cookie: name4=value4

When an HTTP request should be sent from the user terminal 300 to the web server 204, since there is no cookie the scope of which includes the web server 204, the HTTP request is sent with no embedded cookie. In other words, only the following is sent:

(6) GET /index.html

As stated above, an HTTP request is sent from the user terminal 300 to the web server 200 by embedding in the request header of the HTTP request a cookie corresponding to the web server 200 as the destination of the HTTP request based on the scope of the cookie.

The browser 300a of the user terminal 300 receiving a Set-Cookie header together with an HTTP response sets a cookie in the scope indicated in the Set-Cookie header. However, from the standpoint of the browser 300a of the user terminal 300, the source of the HTTP response received at the browser through the reverse proxy 100 is the reverse proxy 100, not the web server 200. In general, values of domain and path parameters in the Set-Cookie header returned from the web server 200 differ from those on the reverse proxy 100, so that the browser 300a receiving the Set-Cookie header ignores the Set-Cookie header or returns a cookie with parameters of the wrong scope.

Therefore, in the present invention, a modification is made so that the browser 300a is allowed to handle the Set-Cookie header transparently even when the response has been returned from the web server 200 to the browser 300a of the user terminal 300 through the reverse proxy 100. In this embodiment, a technique for modifying the Set-Cookie header is used in which the domain parameter (domain related information) included in the Set-Cookie header is deleted and the domain related information is embedded into the path parameter (path related information). Thus, the components of the domain related information are rearranged in inverse order to hierarchically narrow the scope of a cookie set according to the Set-Cookie header. For example, the sequence of components of “www.abc.com” is altered into “com.abc.www”. Further, the character “.” that delimits the components is replaced by “/” and the resultant information is embedded into the information related to the path. The resultant information obtained by converting the FQDN (Full Qualified Domain Name) in the manner mentioned above is called the “reversed FQDN” (reversed Full Qualified Domain Name).

As stated above, the Set-Cookie header is rewritten by deleting the domain information included in the Set-Cookie header, processing the domain information in the same manner as the reversed FQDN, and embedding the resultant information into the information related to the path. Since the Set-Cookie header is thus rewritten, no domain parameter exists in the Set-Cookie header received at the browser 300a, so that the browser 300a does not ignore the Set-Cookie header even if the Set-Cookie header has been sent from the reverse proxy 100. Then, when sending the next or later HTTP request to the scope of a cookie, the browser 300a embeds the cookie into the HTTP request.

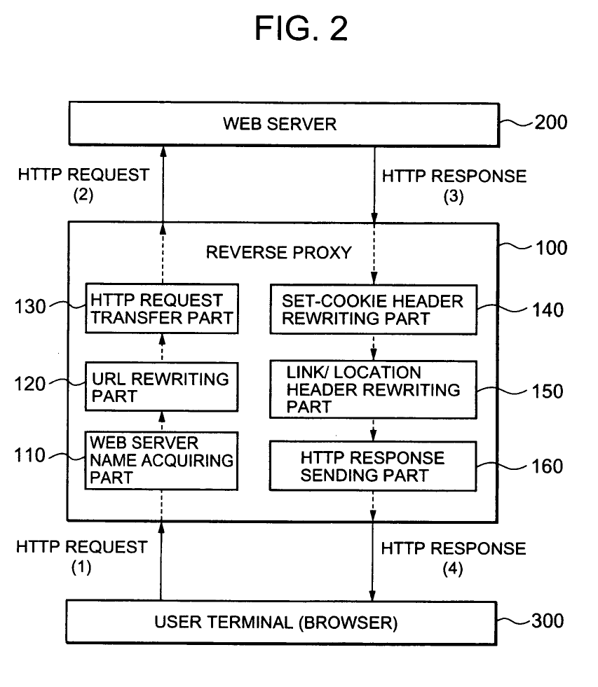

FIG. 2 is a block diagram showing functional blocks of the reverse proxy 100 according to the embodiment. Each of the functional blocks illustrated in FIG. 2 is a software block implemented by the CPU of the reverse proxy 100 under program control.

As shown in FIG. 2, the reverse proxy 100 relaying HTTP requests and HTTP responses includes a web server name acquiring part 110, a URL rewriting part 120, and an HTTP request transfer part 130. The web server name acquiring part 110 identifies a web server 200 to which an HTTP request is to be sent. The URL rewriting part 120 rewrites the URL as the destination of the HTTP request. The HTTP request transfer part 130 transfers the HTTP request to the web server 200. The web server name acquiring part 110, the URL rewriting part 120, and the HTTP request transfer part 130 constitute HTTP request transfer means for transferring an HTTP request to a corresponding web server 200.

In this embodiment, the HTTP request sent from the user terminal 300 and transferred by the request transfer means is addressed in the following format:

http://<reverse proxy>/<prefix>/<path name of web server>

In other words, the HTTP request is transferred to the web server 200 only via the reverse proxy 100.

the reverse proxy 100 also includes a Set-Cookie header rewriting part 140, a link/location header rewriting part 150, and an HTTP response sending part 160. The Set-Cookie header rewriting part 140 rewrites into a predetermined format a Set-Cookie header included in an HTTP response returned from the web server 200. The link/location header rewriting part 150 rewrites the link and location header included in the HTTP response. The HTTP response sending part 160 sends the HTTP response to the user terminal 300 as the destination of the HTTP response rewritten by the Set-Cookie header rewriting part 140 and the link/location header rewriting part 150. The Set-Cookie header rewriting part 140, the link/location header rewriting part 150, and the HTTP response sending part 160 constitute HTTP response transfer means for transferring an HTTP response to a corresponding user terminal 300.

The web server name acquiring part 110 identifies the web server 200, to which the HTTP request is to be sent, from the description in the “prefix” section of the HTTP request. Since information related to the domain of the web server, described with the reversed FQDN, is entered in the “prefix” section of the HTTP request in a manner to be described later, the web server name is acquired directly from the reversed FQDN. Then, the web server name acquiring part 110 retains the web server name as the destination of the HTTP request and sends the HTTP request to the URL rewriting part 120.

The URL rewriting part 120 rewrites the URL as the destination of the HTTP request to specify the path to which the HTTP request is sent in the URL of the web server 200. The URL rewriting part 120 deletes the “prefix” section from the sent HTTP request, and describes the original URL of the Web server 200 as the destination of the HTTP request. In other words, the URL rewriting part 120 alters the sequence of components of information related to the reversed FQDN, and replaces the character (“/”) with (“.”) that delimits the character string or components of the domain related information. For example, if “com/abc/www” (reversed FQDN) exists in the HTTP request as the domain related information, the domain related information will be rewritten to the original domain name “www.abc.com” of the web server 200. Then, the URL rewriting part 120 adds path related information to the domain name to generate the URL of the web server 200 as the destination of the HTTP request, for example “http://www.abc.com/path1/index.html”, and sends the HTTP request to the HTTP request transfer part 130.

The HTTP request transfer part 130 transfers, to the identified URL of the web server 200, the rewritten HTTP request (2) for which the web server name acquiring part 110 has identified the web server name as the destination and the URL rewriting part 120 rewrites the destination URL.

The web server 200 receiving the HTTP request transferred by the reverse proxy 100 returns an HTTP response based on the HTTP request to the user terminal 300 that has sent the HTTP request. The reverse proxy 100 relays the HTTP response.

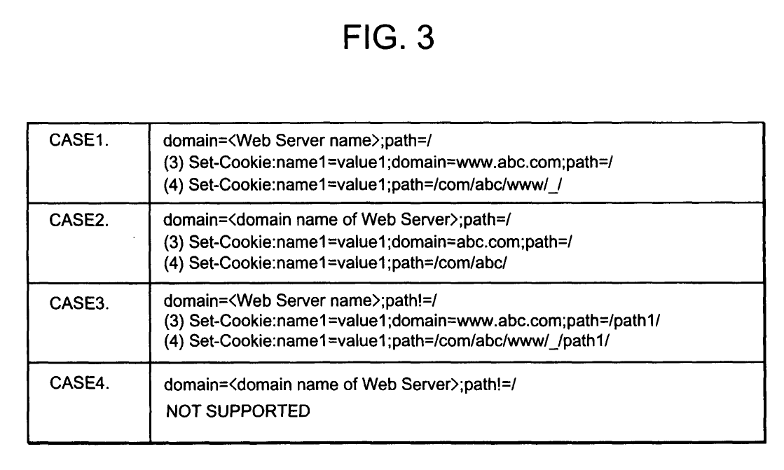

The Set-Cookie header rewriting part 140 rewrites the Set-Cookie header included in the HTTP response returned from the web server 200. Conversion rules for the Set-Cookie rewriting part 140 will be described using the example shown in FIG. 3. FIG. 3 shows conversion rules for deleting the domain parameter included in a Set-Cookie header and converting the path parameter. Here, a description will be made of how to convert the parameter included in the Set-Cookie header in each of four cases, Case 1 to Case 4. In the following examples of conversion rules, the Set-Cookie header included in the HTTP response (3) returned from the web server 200 (shown in FIG. 2) is represented as Set-Cookie header (3), and the Set-Cookie header included in the HTTP response rewritten by the Set-Cookie header rewriting part 140 according to the conversion rules of this embodiment is represented as Set-Cookie header (4).

Case 1: domain=<web server name>; path=/

In other words, when the FQDN of the web server 200 returning the Set-Cookie header is the value of the parameter, and the path in the web server 200 is the path of the web server's root directory as indicated with “/”, the web server 200 returns the following Set-Cookie header:

(3) Set-Cookie: name1=value1; domain=www.abc.com; path=/

Then the Set-Cookie header rewriting part 140 of the reverse proxy 100 converts it to the following Set-Cookie header:

(4) Set-Cookie: name1=value1; path=/com/abc/www/_/

According to the conversion rule shown in Case 1, the domain parameter “domain=www.abc.com” is deleted from the Set-Cookie header. Then, the components of the domain parameter are rearranged in inverse order, and the delimiter is replaced by “/” to generate a reversed FQDN. Finally, the generated reversed FQDN “com/abc/www” is embedded into the path parameter with inserting “_” between the section indicating the domain of the web server 200 in the path parameter and the section indicating the original path in the web server 200. The Set-Cookie header is thus converted to create a new path parameter. It should be noted that although the delimiter “_” is used in the path parameter in this example, any other character which cannot be used for host names but can be used to specify a URL can be used.

Case 2: domain=<domain name of web server>; path=/

In other words, when the domain of the web server 200 returning the Set-Cookie header takes the value of the domain parameter (for example, “abc.com” except “www”), and the path is “/”, the web server 200 returns the following Set-Cookie header:

(3) Set-Cookie: name1=value1; domain=abc.com; path=/

Then the Set-Cookie header rewriting part 140 converts it to the following Set-Cookie header:

(4) Set-Cookie: name1=value1; path=/com/abc/

According to the conversion rule shown in Case 2, the domain parameter “domain=abc.com” is deleted from the Set-Cookie header. Then, the components of the domain parameter are rearranged in inverse order, and the delimiter is replaced by “/” to generate “com/abc”. Finally, the generated “com/abc” is embedded into the path parameter to create the above Set-Cookie header.

Case 3: domain=<web server name>; path!=/

In other words, when the FQDN of the web server 200 returning the Set-Cookie header takes the value of the domain parameter, and the path is not “/”, the web server 200 returns the following Set-Cookie header:

(3) Set-Cookie: name1=value1; domain=www.abc.com; path=/path1/

Then the Set-Cookie header rewriting part 140 converts it to the following Set-Cookie header:

(4) Set-Cookie: name1=value1; path=/com/abc/www/_/path1/

According to the conversion rule shown in Case 3, the domain parameter “domain=www.abc.com” is deleted from the Set-Cookie header. Then, the components of the domain parameter are rearranged in inverse order, and the delimiter is replaced by “/” to generate “com/abc/www”. Finally, a new value of the path parameter, “com/abc/www/_/path1/”, is created from “com/abc/www” and the original value of the path parameter “/path1/”.

Case 4: domain<domain name of web server>; path!=/

In other words, this is a case where the domain of the web server 200 returning the Set-Cookie header takes the value of the domain parameter, and the path is not “/”. The PRESENT embodiment does not support this case, but such a case is less likely to happen because it means that the same path exists in multiple web servers.

The link/location header rewriting part 150 rewrites the contents of the link and location header in an HTTP response. In other words, it rewrites the contents of the link and location header in the HTTP response as follows to show that the HTTP response generated in response to the HTTP request has been sent via the reverse proxy 100:

http://<reverse proxy>/<RFQDN>/_/ . . . ,

where <RFQDN> is a reversed FQDN.

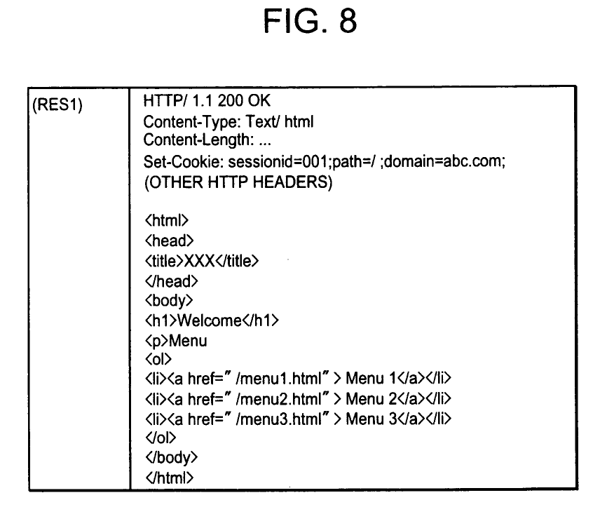

The HTTP response rewritten in the Set-Cookie header rewriting part 140 and the link/location header rewriting part 150 is sent to the HTTP response sending part 160. Data of the HTTP response rewritten in the link/location header rewriting part will be specifically described later with reference to FIGS. 8 to 10.

The HTTP response sending part 160 sends the HTTP response (4) including the Set-Cookie header with the rewritten, reversed FQDN to the browser 300a of the user terminal 300 originating the HTTP request.

When receiving the HTTP response, the browser 300a of the user terminal 300 displays on its window the contents requested in the HTTP request. Further, a cookie is set in the browser 300a according to the Set-Cookie included in the HTTP response.

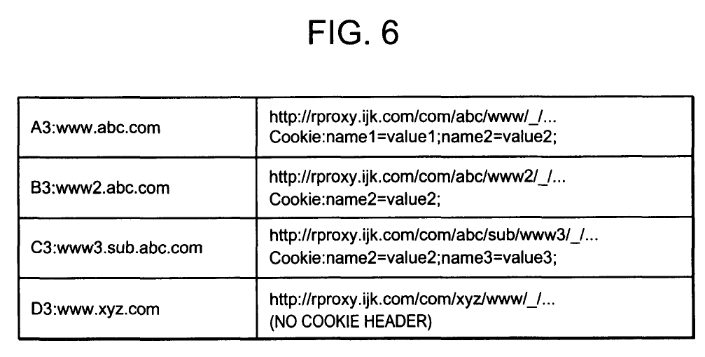

Then, when sending the next or later HTTP request to the web server in the scope of the cookie, the browser embeds the cookie in the request header of the HTTP request. An example of sending the next or later HTTP request with the cookie embedded in the request header will be described later using FIG. 6.

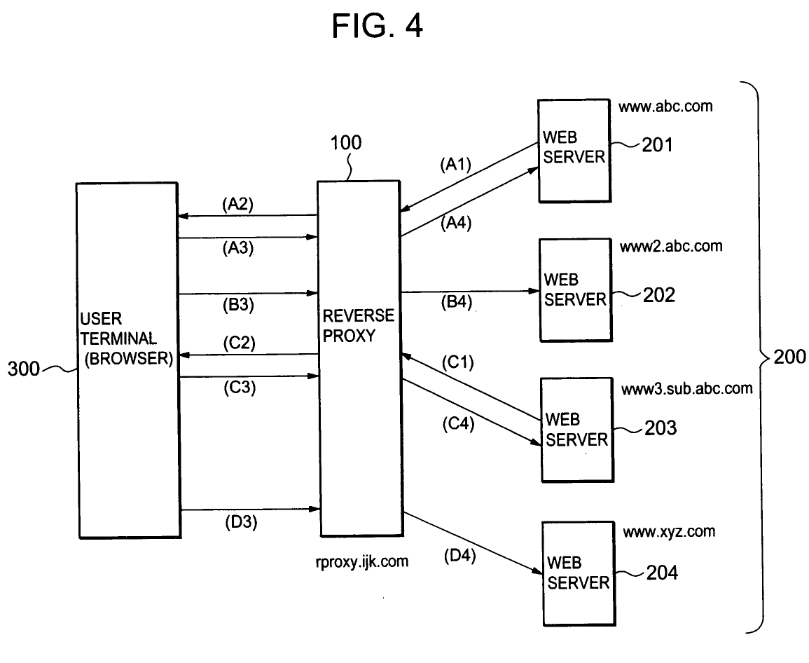

FIG. 4 is a diagram showing a flow of data in the network system according to the present embodiment. It is assumed, for example, that the network system comprises multiple web servers, namely a web server 201 (host name: “www.abc.com”), a web server 202 (host name: “www2.abc.com”), a web server 203 (host name “www3.sub.abc.com”), and a web server 204 (host name: “www.xyz.com”), a reverse proxy 100 (host name: rproxy.ijk.com”), and a user terminal 300.

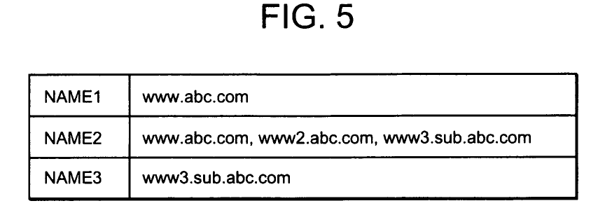

FIG. 4, FIG. 5, and FIG. 6 will be used to illustrate Set-Cookie headers included in HTTP responses to respective HTTP requests originating from the user terminal 300 through the reverse proxy 100. The web server 201 (“www.abc.com”) returns an HTTP response including the following two Set-Cookie headers to set the cookies on the user terminal 300:

(A1) Set-Cookie: name1=value1; domain=www.abc.com; path=/

Set-Cookie: name2=value2; domain=abc.com; path=/

And, the web server 203 (“www3.sub.abc.com”) returns an HTTP response including the following Set-Cookie header to set the cookie on the user terminal 300:

(C1) Set-Cookie: name3=value3; domain=sub.abc.com; path=/

FIG. 5 shows web servers 200 as the scope of cookies corresponding to “name1,” “name2,” and “name3,” respectively. As shown in FIG. 5, the scope of the cookie associated with “name1” includes the web server 201 (“www.abc.com”). The scope of the cookie associated with “name2” includes the web server 201 (“www.abc.com”), the web server 202 (“www2.abc.com”), and the web server 203 (“www3.sub.abc.com”). The scope of the cookie associated with “name3” includes the web server 203 (“www3.sub.abc.com”).

These Set-Cookie headers (A1) and (C1) are converted by the Set-Cookie header rewriting part 140 of the reverse proxy 100 as follows:

One of the Set-Cookie headers (A1), that is,

(A1) Set-Cookie: name1=value1; domain=www.abc.com; path=/ is converted by the conversion rule of the above case 1 to the following:

(A2) Set-Cookie: name1=value1; path=/com/abc/www/_/

The other of the Set-Cookie headers (A1), that is,

(A1) Set-Cookie: name2=value2; domain=abc.com; path=/ is converted by the conversion rule of the above case 2 to the following:

(A2) Set-Cookie: name2=value2; path=/com/abc/

Further, the Set-Cookie header (C1), that is,

(C1) Set-Cookie: name1=value1; domain=www.abc.com; path=/ is converted by the conversion rule of the above case 2 to the following:

(C2) Set-Cookie: name3=value3; path=/com/abc/sub/

Thus, when accessing each of the web servers, the user terminal 300 sends an HTTP request with an embedded cookie or cookies as shown in FIG. 6. In other words, when the user terminal 300 sends an HTTP request to the web server 201, a line containing the name and value pairs of all matching cookies corresponding to the cookie scope shown in FIG. 5 is embedded in the request header of the HTTP request, and as a result the following HTTP request (A3) is sent:

http://rproxy.ijk.com/com/abc/www/_/ . . .

Cookie: name1=value1; name2=value2

When the user terminal 300 sends an HTTP request to the web server 202, a line containing the name and value pair of a matching cookie corresponding to the cookie scope shown in FIG. 5 is embedded in the request header of the HTTP request, and as a result the following HTTP request (B3) is sent:

http://rproxy.ijk.com/com/abc/www2/_/ . . .

Cookie: name2=value2

When the user terminal 300 sends an HTTP request to the web server 203, a line containing the name and value pairs of all matching cookies corresponding to the cookie scope shown in FIG. 5 is embedded in the request header of the HTTP request, and as a result the following HTTP request (C3) is sent:

http://rproxy.ijk.com/com/abc/sub/www3/_/ . . .

Cookie: name2=value2; name3=value3

When the user terminal 300 sends an HTTP request to the web server 204, since there is no cookie corresponding to the HTTP request, the following HTTP request (D3) is sent without any cookie:

Http://rproxy.ijk.com/com/xyz/www/_/ . . .

As stated above, the cookie(s) included in the next or later HTTP request match the web servers 200 as the cookie scope shown in FIG. 5, thus transparently handling the cookie(s) through the reverse proxy 100.

These HTTP requests (A3) to (C3) are subjected to predetermined processing in the web server name acquiring part 110 and the URL rewriting part 120, and converted to HTTP requests (A4) to (C4). Then the HTTP request transfer part 130 transfers the HTTP request (A4) to the web server 201, the HTTP request (B4) to the web server 202, and the HTTP request (C4) to the web server 203, respectively.

Similarly, the HTTP request transfer part 130 transfers the HTTP request (D3) to the web server 204 as an HTTP request (D4). In general, port 80 is used to forward regular HTTP requests. In this embodiment, however, if a port number on a web server 200 other than the default number needs to be explicitly specified, the port number may be specified as follows:

http://<reverse proxy>/<RFQDN>/_<port>/<path name of Web server>

Thus, a port number on the web server 200 can be specified in the “<port>” section, so that even when an unusual port is used as the port on the web server 200 for HTTP requests, the HTTP requests can be sent to the web server 200.

Further, “<RFQDN>_” is used as <prefix>, but even if a fixed-character string, for example “xxx/”, is added as a prefix to the <RFQDN>, the cookie can be transparently handled. For example, suppose that the browser 300a accesses a web page named “/index.html” from the web server 201 (named “www.abc.com”) through the reverse proxy 100. In this case, the following HTTP request is sent:

http://<reverse proxy>/xxx/com/abc/www/_/index.html

Suppose further that the web server 201 returns the following Set-Cookie header:

Set-Cookie: name1=value1; domain=abc.com; path=/

In this case, the reverse proxy 100 converts the Set-Cookie header to the following:

Set-Cookie: name1=value1; path=/xxx/com/abc/

Then the reverse proxy 100 sends the converted Set-Cookie header to the user terminal 300.

In this embodiment, “www.abc.com” is converted to “com/abc/www”. However, upon specification of a domain parameter, only a top-level domain name such as “.com”, “.net”, or “.co.jp” cannot be assigned as the domain parameter. In other words, the domain parameter must be specified from a subdomain, such as “abc.com”, “abc.net”, or “abc.co.jp”, one level lower than the top-level domain. Therefore, the access path to the reverse proxy 100 may be described as follows by combining a minimum set of domain names necessary for specification of the domain parameter:

http://<reverse proxy>/abc-com/www/_/index.html (for A3 in FIG. 4), and

http://<reverse proxy>/abc-com/sub/www3/_/index.html (for C3 in FIG. 4).

The reverse proxy 100 receiving these HTTP requests reads each character string before the delimiter “_” and interprets the destination web server names as “www.abc.com” and “www3.sub.abc.com”, respectively. Then the reverse proxy 100 sends the respective web servers 200 the following HTTP requests:

http://www.abc.com/index.html (for A4 in FIG. 4), and

http://www3.sub.abc.com/index.html (for C4 in FIG. 4).

In response to these HTTP requests, the web servers 200 return the following Set-Cookie headers, for example:

Set-Cookie: id1=001; domain=www.abc.com; path=/; . . . (for A1 in FIG. 4), and

Set-Cookie: id1=001; domain=sub.abc.com; path=/; . . . (for C1 in FIG. 4).

The reverse proxy 100 converts these Set-Cookie headers as follows:

Set-Cookie: id1=001; path=/abc-com/www/_/; . . . (for A2 in FIG. 4), and

Set-Cookie: id1=001; path=/abc-com/sub/; . . . (for C2 in FIG. 4).

Thus, even if <prefix> is described in the above-mentioned manner, the cookie can also be handled transparently.

In the example described using FIG. 4, no domain parameter is specified in the Set-Cookie header returned from the reverse proxy 100. In such a case, the Set-Cookie header represents the server that has sent the HTTP response. Therefore, in the example shown in FIG. 4, the reverse proxy 100 may, for example, replace the domain parameter in the Set-Cookie header by its own server name to specify the server name of the reverse proxy 100 explicitly as follows:

Set-Cookie: name1=value1; path=/com/abc/www/_/; domain=<reverse proxy>

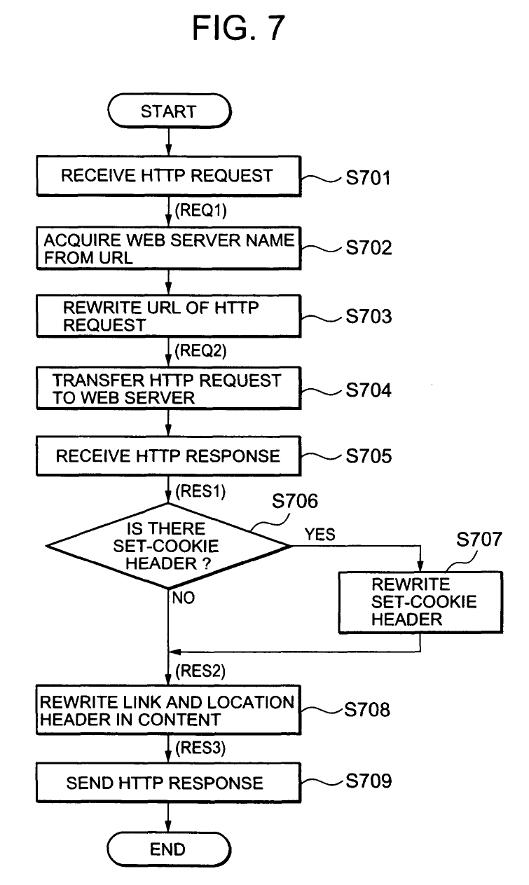

FIG. 7 is a flowchart showing processing in the reverse proxy 100 in accordance with the present invention. FIG. 7 illustrates the processing performed by the reverse proxy 100 on an HTTP request sent from the user terminal 300 and an HTTP response returned from the web server 200. FIGS. 8 to 10 show data (HTTP responses) used in each processing step as described below.

When the user terminal 300 sends an HTTP request with an embedded cookie, the HTTP request received at the reverse proxy 100 is passed to the web server name acquiring part 110 (step 701). It is assumed below that the HTTP request received at step 701 is the following:

(Req1) GET /com/abc/www/_/index.html HTTP/1.1

The web server name acquiring part 110 acquires the name of a web server based on the prefix in the HTTP request received at step 701 (step 702). The web server 200 is thus identified as the destination of the HTTP request. The HTTP request for which the name of the destination web server has been identified in step 702 is sent to the URL rewriting part 120. The URL rewriting part 120 rewrites the URL based on the information acquired in step 702 by the web server name acquiring part 110 (step 703). In other words, the URL rewriting part 120 in step 703 acquires the original URL and path “/www.abc.com/index/html” of the web server 200 as the destination of the HTTP request. The HTTP request for which the web server 200 (“www.abc.com”) as the destination of the HTTP request and the URL (“index.html” indicating the root directory of “www.abc.com”) in the web server 200 have been identified, that is,

(Req2) GET /index.html HTTP/1.1

is sent to the HTTP request transfer part 130. The HTTP request transfer part 130 transfers the HTTP request to the web server 200 identified at step 702 (step 704).

The web server 200 receiving the HTTP request sends the user terminal 300 originating the HTTP request an HTTP response to the HTTP request transferred from the reverse proxy 100. A cookie header is embedded in the HTTP response to maintain user state in future HTTP requests, and the HTTP response with the embedded cookie header is returned. The HTTP response from the web server 200 is returned to the user terminal by way of the reverse proxy 100. In other words, the HTTP response returned from the web server 200 is received at the reverse proxy 100, and passed to the Set-Cookie header rewriting part 140 (step 705).

FIG. 8 shows an example of the HTTP response received at step 705. As shown in FIG. 8, this HTTP response includes the following Set-Cookie header:

Set-Cookie: sessionid=001; path=/; domain=abc.com

The Set-Cookie header includes “sessionid=001” corresponding to ID identifying the user, “path=/” identifying the URL (path) of the web server to which the browser 300a returns the cookie, and “domain=abc.com” identifying the domain of the web server as the destination of the HTTP response. In addition to the above-mentioned information of the Set-Cookie header, the HTTP response also includes various kinds of header information returned from the web server 200.

As soon as the reverse proxy 100 receives the HTTP response, the Set-Cookie header rewriting part 140 determines whether a Set-Cookie header exists in the HTTP response (step 706). When determining in step 706 that a Set-Cookie header exists in the HTTP response, the Set-Cookie header rewriting part 140 rewrites the Set-Cookie header (step 707). The Set-Cookie header is rewritten according to the conversion rules shown in FIG. 3. In other words, the Set-Cookie header rewriting part 140 deletes the domain parameter, rearranges the components of the domain parameter in inverse order, and replaces the delimiter “.” by “/”. Then the Set-Cookie header rewriting part 140 embeds the rewritten information into the path parameter of the Set-Cookie header. When the Set-Cookie header rewriting part 140 determines in step 706 that no Set-Cookie header exists in the HTTP response, step 707 is omitted.

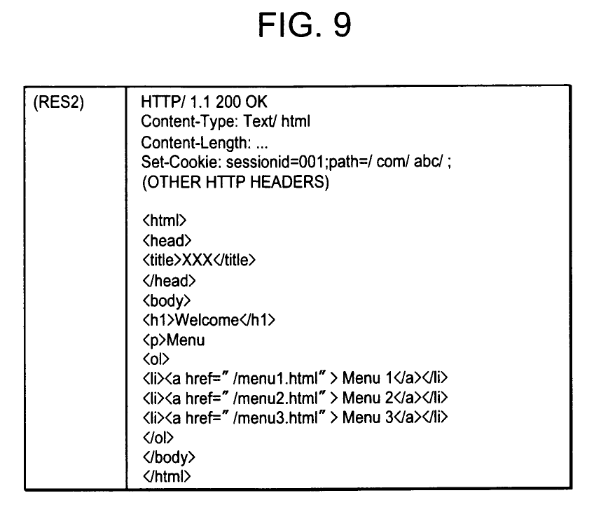

FIG. 9 shows an example of the HTTP response with the Set-Cookie header rewritten in step 707:

Set-Cookie: sessionid=001; path=/com/abc/

FIG. 9 shows that the above Set-Cookie has been rewritten according to the conversion rules shown in FIG. 3.

The HTTP response with the Set-Cookie header rewritten in step 707 to the reversed FQDN is sent from the Set-Cookie header rewriting part 140 to the link/location header rewriting part 150. The link/location header rewriting part 150 receiving the HTTP response rewrites link and location headers in the contents (step 708).

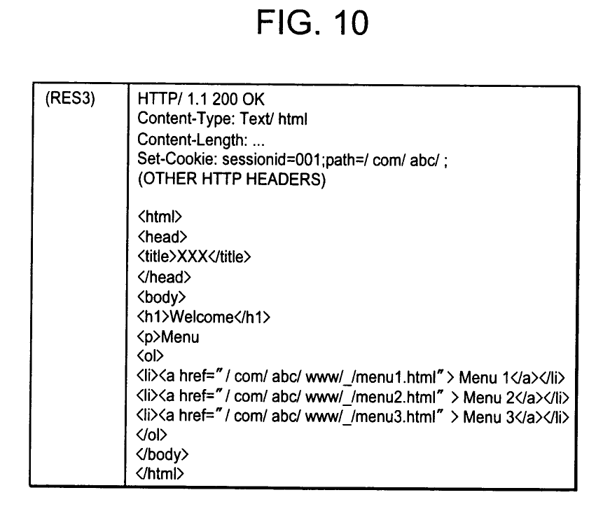

FIG. 10 shows an example of the HTTP response with rewritten links. The following are link destination specifying parts shown in FIGS. 8 and 9:

“/menu1.html”

“/menu2.html”

“/menu3.html”

As shown in FIG. 10, these link destination specifying parts are rewritten in step 708 to the following absolute paths with the reversed FQDN added to them:

“/com/abc/www/_/menu1.html”

“/com/abc/www/_/menu2.html”

“/com/abc/www/_/menu3.html”

The HTTP response including the Set-Cookie header thus rewritten in a format recognizable by the browser is sent from the HTTP response sending part 160 to the user terminal 300 that has sent the HTTP request received at step 701 (step 709). Then the contents based on the HTTP response, and data and files linked to the HTTP response are displayed on the browser of the user terminal 300, and a cookie of a predetermined scope based on the Set-Cookie header in the HTTP response is kept and stored in the browser.

The reverse proxy 100 deletes the domain parameter and sends the user terminal the Set-Cookie header with the rewritten path parameter. As a result, a cookie is set and kept in the browser 300a of the user terminal 300 based on the Set-Cookie header included in the HTTP response returned through the reverse proxy 100.

Then, when receiving the next/later HTTP request with a cookie header from the browser 300a, the reverse proxy 100 transfers the cookie header as it is to a corresponding one of the web servers 200. Thus, the cookie is only sent to the domain and path specified by the web server 200 in the Set-Cookie header.

As described above and according to the invention, a cookie set by a server can be transparently handled in a network system in which a client accesses the server via a reverse proxy. According to the invention, there can also be a reverse proxy with Set-Cookie rewriting capability for transparently handling a cookie set by a server.

What is claimed:

1. A network system including multiple web servers provided on a network and a reverse proxy relaying external access to the multiple web servers, wherein:
a selected one of the multiple web servers responds to a request from a certain terminal connected to the network to return to said terminal a response including information for maintaining a state of said terminal; and
the reverse proxy converts said information for maintaining said state of said terminal, into a format recognizable by said terminal as a configuration of the network, and returns said response with said converted information.

2. The network system according to claim 1, wherein the reverse proxy deletes a domain parameter specifying a domain of said selected one of the multiple web servers included in said information for maintaining said state of said terminal, and embeds said domain parameter into a path parameter of said selected one of the multiple web servers included in said information.

3. The network system according to claim 2, wherein the reverse proxy rearranges components of said domain parameter in inverse order and embeds said rearranged domain parameter into said path parameter.

4. A reverse proxy relaying data from a web server to a user terminal, comprising:
a header rewriting part for receiving the data returned from the web server to the user terminal, and rewriting a domain included in the data into a format recognizable by the user terminal; and
a data sending part for sending the user terminal said data rewritten by said header rewriting part.

5. The reverse proxy according to claim 4, wherein said header rewriting part rearranges in inverse order a description of the domain included in the data to generate a path including said description of the domain rearranged in inverse order.

6. The reverse proxy according to claim 4, further comprising a link/location rewriting part for rewriting the domain and path of a link and location included in the data in conformity to said path including said description of the domain rewritten by said header rewriting part.

7. The reverse proxy according to claim 4, further comprising:
a web server name acquiring part for receiving a request sent from the user terminal to the web server, and identifying based on said request a web server as an access destination of said request from among multiple servers on the network;
a URL rewriting part for rewriting an access path described in said request to an original path in the web server based on said request; and
a request transfer part for transferring said request to the web server indicated by the request.

8. A reverse proxy relaying a request from a user terminal to a web server, comprising:
a web server name acquiring part for identifying the web server, to which the request is to be sent, from among a plurality of web servers on a network based on information obtained by converting a description of the received request;
a URL rewriting part for rewriting an access destination of the request to a URL of the web server based on an identification of the web server identified by said web server name acquiring part; and
a request transfer part for transferring the request to said URL of the web server.

9. Computer equipment relaying transmission of an HTTP request and return of an HTTP response between a terminal and a server; comprising:
HTTP request transfer means for relaying the HTTP response with a cookie sent from a browser of the terminal to transfer the HTTP request with said cookie to the server as a destination of the HTTP request; and
HTTP response transfer means for receiving the HTTP response returned from the server in response to the HTTP request, deleting a domain described in a Set-Cookie header, rearranging components of said domain into an inverse order, embedding said rearranged components into a path described in said Set-Cookie header, and transferring the HTTP response with said Set-Cookie header to the terminal.

10. The computer equipment according to claim 9, wherein said HTTP request transfer means specifies a port number of a communication port on the server together with said domain of the server, and transfers the HTTP request to the server.

11. The computer equipment according to claim 9, wherein said HTTP response transfer means adds a predetermined fixed-character string to said Set-Cookie header according to the HTTP response, and transfers the HTTP response with said Set-Cookie header to the terminal.

12. The computer equipment according to claim 9, wherein said HTTP response transfer means compiles components necessary for identifying said domain when rearranging them in inverse order, and transfers the HTTP response to the terminal.

13. The computer equipment according to claim 9, wherein said HTTP response transfer means replaces a domain parameter of the server in said Set-Cookie header by its own server name, and transfers the HTTP response to the terminal.

14. A data processing method for relaying data exchanged between first computer equipment and second computer equipment, comprising the steps of:
receiving a response sent from the first computer equipment to the second computer equipment;
determining whether said response includes a Set-Cookie header;
rewriting said Set-Cookie header when said response includes said Set-Cookie header so that a cookie set on the second computer equipment based on said Set-Cookie header will have a format recognizable by the second computer equipment; and
sending the second computer said response with said rewritten Set-Cookie header.

15. A program product for controlling computer equipment relaying data exchanged between first computer equipment and second computer equipment to perform predetermined data processing, comprising:
first processing means for receiving a response sent from the first computer equipment to the second computer equipment;
second processing means for rewriting a Set-Cookie header when said response includes said Set-Cookie header so that a cookie set on the second computer equipment based on said Set-Cookie header will have a format recognizable by the second computer equipment; and
third processing means for sending the second computer equipment said response with said rewritten Set-Cookie header.

16. The program product according to claim 15, wherein during processing in said second processing means for rewriting said Set-Cookie header, a sequence of a domain included in said Set-Cookie header of said response is altered into an inverse order, and a delimiter of said domain is replaced by a predetermined character to generate a path including said domain rearranged into said inverse order.

17. The program product according to claim 15, further comprising means for controlling the first and second computer equipment to rewrite said domain and said path of a link and location included in said response in conformity with said path included in said Set-Cookie header.

18. A program product for controlling computer equipment relaying data exchanged between first computer equipment and second computer equipment to perform predetermined processing, comprising:
processing means for receiving a request sent from the second computer equipment identifying the first computer equipment, to which said request is to be sent, based on information obtained by converting a description of said received request;
processing means for rewriting an access destination of said request to a URL of the first computer equipment identified; and
processing means for sending said request to said URL of the first computer equipment.
